(19) United States
(12) Patent Application Publication
(10) Pub. No.: US 2019/0151974 A1
(43) Pub. Date: May 23, 2019

(54) METHODS FOR JOINING MATERIALS, AND MATERIAL COMPOSITE

(71) Applicant: Siemens Aktiengesellschaft, Munich (DE)

(72) Inventors: Robin Blank, Berlin (DE); Thomas Nägel, Berlin Charlottenburg-Wilmersdorf (DE); Ingo Reinkensmeier, Fröndenberg (DE)

(73) Assignee: Siemens Aktiengesellschaft, Munich (DE)

(21) Appl. No.: 16/315,192

(22) PCT Filed: Aug. 2, 2017
(86) PCT No.: PCT/EP2017/069559

§ 371 Date: Jan. 4, 2019

(30) Foreign Application Priority Data
Aug. 9, 2016 (DE) 10 2016 214 742.0

(51) Int. Cl. B23K 1/00; B22F 3/105; B23K 15/00

(52) U.S. Cl. CPC B23K 1/0018; B23K 1/19; B23K 15/0093; B22F 3/1055

(57) ABSTRACT

A method for joining materials, includes: providing a first material and a second material, providing the first material with a grid structure at a joining point, and joining, in particular soldering, the second material to the grid structure such that a material composite of the first material and the second material is produced, wherein the grid structure is designed in such a way that stresses in the material composite are at least partly compensated by the grid structure.

### CROSS REFERENCE TO RELATED APPLICATIONS

This application is the US National Stage of International Application No. PCT/EP2017/069559 filed Aug. 2, 2017, and claims the benefit thereof. The International Application claims the benefit of German Application No. DE 10 2016 214 742.0 filed Aug. 9, 2016. All of the applications are incorporated by reference herein in their entirety.

### FIELD OF INVENTION

The present invention relates to a method for joining or connecting materials and a material compound or a corresponding composite material.

The materials can be present or provided, for example, in the form of finished elements or partially manufactured elements.

The stated elements can be elements for use in a turbo machine, advantageously a gas turbine. The element is advantageously composed of a superalloy, in particular a nickel or cobalt-based superalloy. The superalloy can be precipitation-hardened or capable of being precipitation-hardened. The element is advantageously used in a hot gas path or hot gas region of a turbo machine, such as a gas turbine.

### BACKGROUND OF INVENTION

A composite coating for a gas turbine, comprising a metal substrate, a carrier substrate and a ceramic filler as well as a method for producing the composite coating is described, for example, in EP 1 165 941 B1.

During joining, for example, by soldering, of different types of substances, for example, metal and ceramic, tensions frequently occur in the region of the connection point (soldering point) as a result of different thermally induced expansion characteristics or thermal coefficients of expansion of both materials.

The various thermal expansions reduce the strength properties as a result of mechanical, thermal and/or thermomechanical tensions which occur in the region of the connection point of the materials and/or in the materials.

As a result of the stated tensions, cracks and/or the detachment of individual layers or in composite components arise in particular during operation of composite elements or composite materials under high thermal load. This is in particular a problem in the case of turbine components on which hot gas acts, such as, for example, blades or other hot gas parts. In the worst case, the different thermal expansions can even lead to the destruction of the characteristic properties at least of one of the two materials.

The stated mechanical tensions impair the strength of a corresponding composite element in particular as a result of the fact that temperature gradients occur both within individual joining components, for example, metallic and/or ceramic materials as well as along a connection of the corresponding joining or composite components.

This problem was previously solved by the use of, in particular ductile, intermediate layers, adhesion layers or buffer layers in the range of a thickness of, for example, one or a few millimeters. These layers at least partially balance out the different described, thermally induced expansions of the joining components, for example, as a result of elastic and/or plastic deformation or bring about a relaxation of the tensions which occur, for example, in the region of the solder connection. The buffer layers can be copper, silver and/or titanium-based layers which normally have, however, low oxidation resistance and are correspondingly unsuitable as joining components or elements to be joined which are designed for a high thermal load capacity.

A further disadvantage of these buffer or intermediate or adhesion layers relates to their capacity to be produced in only comparatively small layer thicknesses since the layer thicknesses can be restricted by the imbalance between the thermal coefficients of expansion of the joining materials involved, and not every “mismatch” of the thermal expansion of the joining partners across buffer layers can be balanced out. The involvement of these intermediate layers furthermore complicates the joining process and potentially brings further sources of contamination into the composite material.

### SUMMARY OF INVENTION

One object of the present invention is therefore to indicate an improved method for joining materials, as well as a correspondingly improved material compound. In particular, an improved method is presented which enables the joining of connections or components of different types without intermediate layers and in a quasi-one-stage joining, in particular soldering process. In other words, no intermediate, buffer or adhesion layer is to be provided any more between the joining parameters. No metallization, for example, of the second material is furthermore necessary.

This object is achieved by the subject matter of the independent claims. Advantageous configurations are the subject matter of the dependent claims.

One aspect of the present invention relates to a method for joining materials and a method for producing a material compound or a composite material.

The method comprises the provision of a first material or joining partner and the provision of a second material or joining partner.

The first material can be, for example, a metallic material.

The second material can be, for example, a ceramic material.

The method further comprises the provision of the first material at a connection point or joining point of the first material with a grid structure. The connection point advantageously designates a side or edge of the material, for example, a surface, provided for connection or joining.

In one configuration, the method comprises the provision of the grid structure and/or the second material with a solder.

The method furthermore comprises the connection, in particular the soldering of the second material to the grid structure or vice versa so that a composite material or material compound composed of the first material and the second material is generated, wherein the grid structure is formed such that tensions in the material and as a result of the grid structure are at least partially or entirely compensated.

By providing the first material with the grid structure, a reduction in tension can be carried out by absorbing the tensions by means of the grid structure, as indicated above, advantageously in a similar manner to the mode of operation of the buffer layer. However, in contrast to the use of an intermediate or buffer layer, one is advantageously bound neither to a specific layer thickness, nor is there the risk of introducing contamination into the material compound. This is in particular the case since the grid structure is constructed or provided advantageously inherently in the case of the element or the component of the first material and is accordingly advantageously composed of precisely the same material as the first material or a material of the same type. For this reason, the composite material can equally be formed to be more temperature-resistant and/or oxidation-resistant than, for example, a compound comprising an intermediate layer.

The first material and the second material can both be present in the form of a component or an element.

The connection of the second material to the grid structure or via the grid structure to the first material advantageously involves soldering, in particular hard soldering. The solder can be, for example, a hard solder and/or an active solder.

In one configuration, the first material is a metallic material, in particular a nickel- or cobalt-based superalloy or an element composed thereof or comprising the alloy or a corresponding composite component. The first material can accordingly represent a turbine component, for example, a component used in the hot gas path of a gas turbine. The stated alloy can be a superalloy which is precipitation-hardened or capable of being precipitation-hardened, for example, an alloy hardened by the γ- or γ′-phase or its phase precipitation.

In one configuration, the second material is a ceramic material, for example, a ceramic fiber composite material.

The connection of a metallic material to a ceramic material or vice versa potentially represents a particularly interesting and functional combination in particular in the case of the production of turbine components.

In one configuration, the grid structure is produced or composed of the same material as the first material. Accordingly, the first material can form, for example, together with the grid structure, a functionally independent component or an element.

In one configuration, the grid structure is a face centered cubic or fcc grid.

In one configuration, the grid structure has grid struts with a diameter or a width of between 0.5 mm and 2.5 mm, in particular of 1.5 mm.

In one configuration, the grid structure has spatial diagonals of a corresponding elementary cell of the grid formed by the grid structure between 4 mm and 8 mm, in particular 6 mm.

These configurations are in particular expedient and advantageous for solving the object on which the invention is based. In particular, a relaxation of tension as described above can be achieved particularly advantageously by the described geometries and dimensions.

The grid structure is produced with an additive production method, for example, selective laser melting or electron beam melting. In other words, the first material is advantageously provided with the grid structure by means of the described methods.

In one configuration, the first material is produced with an additive production method, for example, selective laser melting or electron beam melting.

These configurations have the advantage that the grid structure is provided without great outlay in terms of process inherently together with the first material or the component which represents or comprises it.

Additive production methods possibly enable in the first place the construction of grid structures since correspondingly complex, nested and/or branched structures cannot be produced with conventional (subtractive or machining/milling) production under certain circumstances. Additive production methods are furthermore known to have the advantage of an almost unlimited freedom of design.

Generative or additive production methods comprise, for example, selective laser melting (SLM) or electron beam melting (EBM). The stated beam welding methods include, for example, electron beam welding or laser deposition welding.

Additive manufacturing methods have been shown to be particularly advantageous for elements which are complex or of a complicated or intricate design, for example, labyrinth-like structures, cooling structures and/or lightweight structures. In particular, additive manufacture by means of a particularly short chain of process steps is advantageous since a production or manufacturing step of an element can be carried out directly on the basis of a corresponding CAD file.

In one configuration, the grid structure is produced or provided in the same production method, advantageously directly, together with the first material in order to form a composite component.

In one configuration, the stated composite component is a part of a gas turbine, advantageously a part thereof upon which hot gas acts during operation of the gas turbine.

In one configuration, the second material is soldered via the grid structure to the first material.

In one configuration, the stated solder is a hard and/or active solder and contains, for example, silver, copper and/or titanium.

In one configuration, the grid structure is, expediently prior to connection or soldering, infiltrated or filled with a solder/binder mixture and/or a solder/filler mixture. Under certain circumstances, this has the advantage that the grid structure can be further mechanically stabilized, wherein it is not necessary to dispense with the tension-relaxing properties of the grid structure in terms of thermally induced tensions.

The stated solder/binder mixture or solder/filler mixture can also comprise, for example, a hard solder and/or an active solder.

A further aspect of the present invention relates to a material compound which is advantageously produced or can be produced according to the method described above.

In one configuration, the grid structure in the stated material compound is connected directly and in a firmly bonded manner to the first material.

In one configuration, a hard solder, active solder and/or the stated solder mixture are arranged between the grid structure and the second material and/or in grid spaces of the grid structure.

In one configuration, the active solder contains titanium. This configuration enables high temperature resistance of the material compound. This configuration furthermore advantageously enables by means of a secondary phase formation complete wetting of a surface of the second material or the ceramic surface by the solder.

In one configuration, the first material is a gas turbine component, in particular a component used in a hot gas path of the gas turbine, or represents this.

In one configuration, the material compound does not have a buffer or adhesion layer for balancing out mechanical tensions. The material compound is correspondingly advantageously free from the stated buffer or adhesion layer. In other words, a mechanical relaxation of tension can be brought about exclusively by the configuration of the grid structure or substantially as a result of it.

Configurations, features and/or advantages which relate to the method in the present case can furthermore relate to the material compound or vice versa.

### BRIEF DESCRIPTION OF THE DRAWINGS

Further details of the invention are described below on the basis of the figures.

FIG. 1 shows a schematic sectional or side view of components of a material compound according to the invention.

FIG. 2 shows at least partially a schematic sectional or side view of the material compound.

FIG. 3 schematically indicates, on the basis of a flow chart, method steps of a method according to the invention for joining materials.

FIGS. 4 to 7 indicate tension conditions of the material compound according to the invention schematically and in a simplified form.

### DETAILED DESCRIPTION OF INVENTION

In the exemplary embodiments and figures, identical elements or elements with the same effect can be provided in each case with the same reference numbers. The represented elements and their size ratios to one another should fundamentally not be regarded as true-to-scale, on the contrary, individual elements can be represented with exaggerated thickness or size dimensions for the purpose of ease of representation and/or better understanding.

A method for joining materials or a method for producing a material compound according to the present invention is described below on the basis of the figures.

The method is a method for joining or connecting materials, in particular a first material W1 and a second material W2. The method advantageously describes a soldering method for soldering first material W1 to second material 2 or vice versa.

In particular, the method comprises the provision of first material W1 (cf. a) in FIG. 3). The first material can be, for example, a metallic material. The first material can furthermore be present in the form of an element or a component, advantageously a turbine component or a component used, for example, in the hot gas path of a gas turbine. The first material can accordingly comprise a superalloy, for example, a nickel- or cobalt-based superalloy or be composed of this.

The stated alloy can be a superalloy which is precipitation-hardened or capable of being precipitation-hardened, for example, a superalloy hardened by the γ- or γ′-phase or its phase precipitation. Alternatively, the first material can designate another material.

The method furthermore comprises the provision of second material W2. The second material can be a ceramic material. In particular, the second material can be a ceramic fiber composite material, for example, a CMC material (“ceramic matrix composite”). Alternatively, the second material can designate another material.

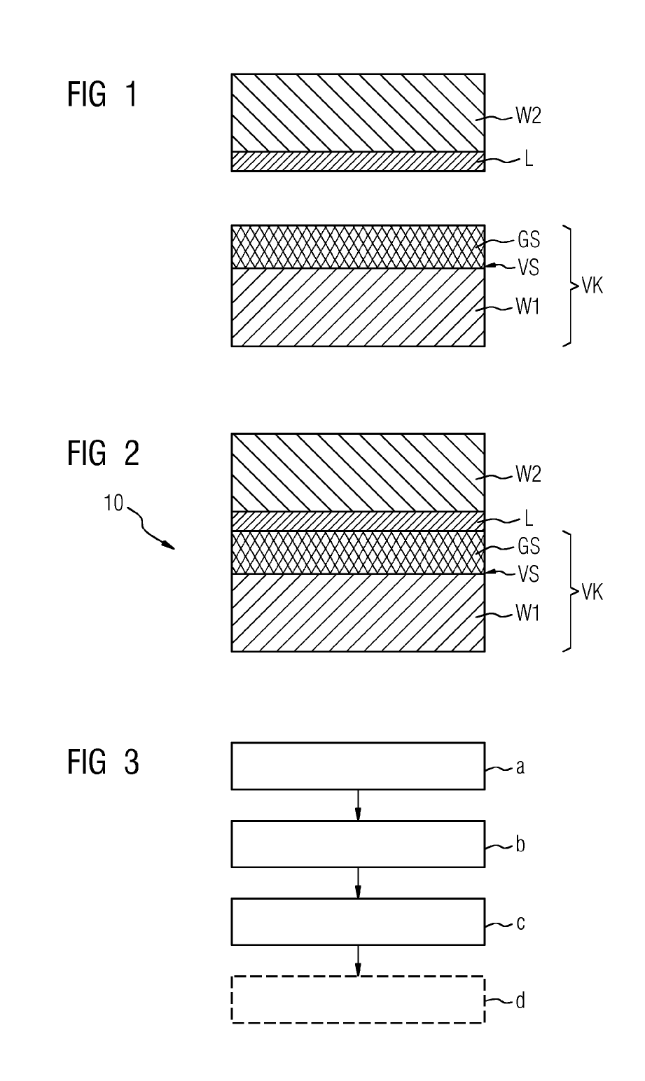

First material W1 is indicated at the bottom in FIG. 1, and second material W2 is indicated at the top in FIG. 1. A corresponding component, for example, a first component and a second component, can be designated synonymously respectively with the first material and the second material.

The method furthermore comprises providing first material W1 with a grid structure GS, and indeed at a connection point VS provided for the joining or the connection (cf. b) in FIG. 3). In FIG. 1, first material 1 is represented already provided or connected with/to grid structure GS advantageously in a firmly bonded manner.

Connection point VS advantageously designates an upper side of the first material or the corresponding element, which upper side is to be connected or joined to second material W2.

A relaxation of tension for a material compound generated from the first material and the second material should advantageously be brought about according to the invention via grid structure GS. Grid structure GS is accordingly advantageously arranged and formed in such a manner that tensions, i.e. mechanical, thermal and/or thermomechanical tensions, which would arise, for example, without the provision of grid structure GS in the case of a connection or soldering of the first material to the second material can be at least partially or substantially balanced out or compensated.

As a result of grid structure GS, an intermediate or buffer layer can advantageously be omitted, which layer is provided, for example, to balance out differences in the thermal coefficients of expansion of the components to be guided. As a further advantage, the joining according to the invention enables via a corresponding grid structure GS the formation of the material compound with particularly high temperature resistance which is improved in comparison with substances with conventional intermediate or buffer layers on a silver and/or copper basis.

A material compound which is produced according to the invention also advantageously has improved oxidation resistance in comparison with conventional or conventionally joined composite materials.

Grid structure GS can have, for example, grid spacings and/or grid diameters in the range of tenths of a millimeter up to a few millimeters or centimeters.

The grid structure can be a face centered cubic or fcc grid. Grid structure GS can furthermore have grid struts (not explicitly labeled) with a diameter of between 0.5 mm and 2.5 mm, in particular of 1.5 mm and spatial diagonals of a corresponding elementary cell of the grid with dimensions between 4 mm and 8 mm, in particular 6 mm.

Grid structure GS can also be functionally assigned to the component represented by the first material. In other words, according to the present invention, an element which is to be correspondingly joined and can be produced from the first material can be provided inherently during production with grid structure GS.

The first material and the grid structure are accordingly advantageously produced or capable of being produced from the same or identical materials.

An additive production method, for example, selective laser melting (SLM), electron beam melting (EBM) or also selective laser sintering is advantageously called on for advantageous and/or expedient production of the component of first material W1 and/or grid structure GS.

The design of grid structure GS in the structure of first material W1 or providing first material W1 with grid structure GS is therefore advantageously carried out in the same production method by means of additive methods in layers.

Grid structure GS is correspondingly advantageously connected in a firmly bonded manner to the first material and arranged directly thereon.

A corresponding connection point of the first material and providing this with grid structure GS for connection to the second material can in this sense already be intended in the production or provision of the first material.

The first material provided with grid structure GS advantageously represents a composite component VK which is provided for subsequent joining or connection to the second material.

Composite component VK can be, for example, a component which is manufactured or prefabricated monolithically or from one piece or the same material or the same type of material (metal) for a gas turbine or a hot gas part of a gas turbine. This can be a, in particular uncoated, turbine blade and/or a component of a turbine blade or combustion chamber, which component has advantageously not yet been provided with a heat insulation and/or oxidation protective coating.

The method further comprises connecting, in particular soldering, second material W2 to grid structure GS so that a material compound 10 (cf. FIG. 2) is generated (cf. c) in FIG. 3). In addition to composite component VK, only solder layers L and second material W2 are indicated schematically in FIG. 1.

Soldering is advantageously carried out by means known to the person skilled in the art and at correspondingly expedient temperatures, in particular at temperatures of above 700° C., advantageously above 800° C., for example, 1050° C.

In the case of soldering, in particular at least one of the components—selected from grid structure GS and second material—is provided with the solder and the respective other component is then joined at the corresponding solder temperature. As represented in FIG. 1, both grid structure GS and second material W2 can initially, optionally with heating to a solder temperature, be provided with a solder and subsequently joined.

FIG. 2 shows material compound 10 which was generated by the method according to the invention from the first material and the second material.

In contrast to the representation in the figures, grid structure GS can be provided with a solder/binder mixture and/or a solder/filler mixture for soldering, or grid spaces of grid structure GS can be filled or infiltrated with the stated mixture. This can be advantageous both for the mechanical stability of material compound 10 and for the object according to the invention, i.e. for example balancing out mechanical tensions in material compound 10.

Material compound 10 shown in FIG. 2 advantageously has no buffer or adhesion layer for balancing out mechanical tensions.

FIG. 3 shows the method steps according to the invention on the basis of a flow chart.

The method step labelled with reference number a) relates to the provision of first material W1 and second material W2.

Method step b) relates to the provision of first material W1 with grid structure GS, as described above.

Method step c) relates to the connection, in particular soldering, of second material W2 to grid structure GS so that—as described above—material compound 10 is generated.

Alternatively, the connection of the first material and the second material can be performed by another joining method, for example, by welding, pressing, gluing, shaping or sintering.

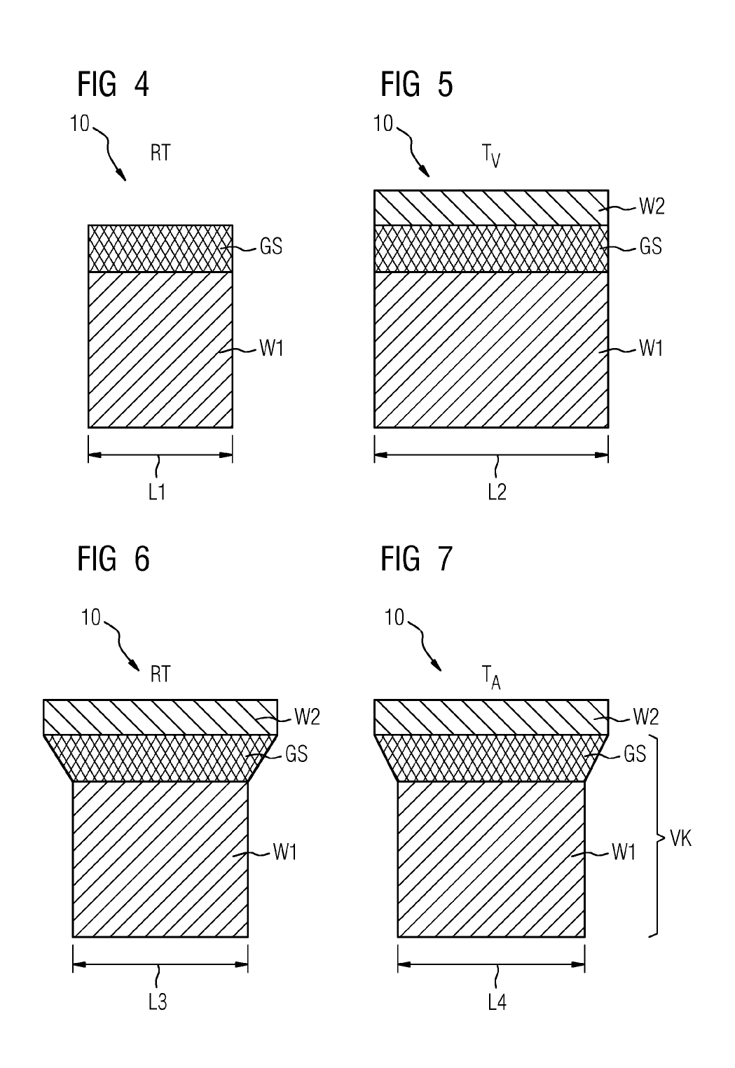

FIG. 4 schematically shows an alternative formation of first material W1 provided with the grid structure in an analogous manner to the representation of FIG. 1. In the horizontal direction, first material W1 and grid structure GS connected thereto have a length or width L1. This length advantageously corresponds to the length of the corresponding components at room temperature RT.

FIG. 5 schematically shows the same structure from FIG. 1, wherein, however, additionally second material W2 was connected to the grid structure at a temperature Tᵥ (cf. above). Temperature Tᵥ corresponds, for example, to a temperature between 800° C. and 1050° C. or also more or less. In contrast to the representation of FIG. 4, it is apparent that—as a result of the thermal expansion—first material W1 or corresponding material compound 10 has a length L2 greater than L1.

FIG. 6 schematically shows a cooling of material compound 10 from temperature Tᵥ (again) to room temperature RT. As a result of the cooling, first material W1 has reduced in size or contracted to length L3 (greater than L1 and L2), wherein, however, the corresponding length or width (not explicitly labeled) of second material W2 has not reduced in size to the same degree as a result of its material properties so that a first mechanical tension should exist via the connection between first material W1 and second material W2 and balanced out by grid structure GS.

Finally, in FIG. 7, the material compound is represented at a working temperature T_{A}, wherein first material W1—starting from room temperature RT—has expanded to a length L4 (greater than L3). At the same time, as a result of the increase in temperature, second material W2 also expands, for example, slightly in terms of length. It is, however, apparent on the basis of the smaller difference in length that a second mechanical tension—which is also balanced out by grid structure GS—is thus present. The second mechanical tension is advantageously smaller than the described first mechanical tension (cf. FIG. 6).

In other words, it is described on the basis of FIGS. 4 to 7 that grid structure GS is advantageously provided or first material W1 is provided with grid structure GS in such a manner that a relaxation of tension is adapted as expediently as possible to a hot state or to working temperature T_{A}, i.e. an expediently lower mechanical tension prevails in material compound 10 in this hot or operating state and accordingly is or can be also advantageously balanced out via grid structure GS.

The invention is not restricted by the description on the basis of the exemplary embodiments to these, rather also encompasses any new feature and any combination of features. This contains in particular any combination of features in the claims even if this feature or this combination is itself not explicitly indicated in the claims or exemplary embodiments.

1. A method for joining materials, comprising:
a) providing a first material and a second material,
b) providing the first material at a connection point with a grid structure, wherein the grid structure is produced with an additive production method or selective laser melting or electron beam melting, and
c) connecting or soldering, the second material to the grid structure so that a material compound is generated from the first material and the second material, wherein the grid structure is formed in such a manner that tensions in the material compound are at least partially compensated by the grid structure.

2. The method as claimed in claim 1,
wherein the first material is a metallic material, or a nickel- or cobalt-based superalloy.

3. The method as claimed in claim 1,
wherein the second material is a ceramic material, or a ceramic fiber composite.

4. The method as claimed in claim 1,
wherein the grid structure is produced from the same material as the first material.

5. The method as claimed in claim 1,
wherein the first material is produced with an additive production method, or selective laser melting or electron beam melting.

6. The method as claimed in claim 1,
wherein the grid structure is produced in the same production method with the first material in order to form a composite component.

7. The method as claimed in claim 6,
wherein the composite component is a part of a gas turbine, or a part of a gas turbine upon which hot gas acts.

8. The method as claimed in claim 1,
wherein the second material is soldered via the grid structure to the first material and the grid structure is infiltrated with a solder/binder mixture.

9. A material compound produced and/or capable of being produced from a first material with a grid structure and a second material by the method according to claim 1,
wherein the grid structure is connected directly and in a firmly bonded manner to the first material.

10. The material compound as claimed in claim 9,
wherein the grid structure has grid struts with a diameter of between 0.5 mm and 2.5 mm.

11. The material compound as claimed in claim 9,
wherein the grid structure has spatial diagonals of a corresponding elementary cell of the grid formed by the grid structure between 4 mm and 8 mm.

12. The material compound as claimed in claim 9,
wherein an active solder is arranged between the grid structure and the second material and/or in grid spaces of the grid structure.

13. The material compound as claimed in claim 9,
wherein the first material is a gas turbine component, or a component used in a hot gas path of a gas turbine.

14. The material compound as claimed in claim 9,
which does not have a buffer or adhesion layer for balancing out mechanical tensions.

15. The material compound as claimed in claim 10,
wherein the grid structure has grid struts with a diameter of 1.5 mm.

16. The material compound as claimed in claim 11,
wherein the grid structure has spatial diagonals of a corresponding elementary cell of the grid formed by the grid structure of 6 mm.

17. The material compound as claimed in claim 12,
wherein the active solder contains titanium.
